(19) United States
(12) Patent Application Publication
(10) Pub. No.: US 2013/0157378 A1
(43) Pub. Date: Jun. 20, 2013

(54) ATTENUATING DYE FOR INTERROGATING MULTIPLE SURFACES, AND METHOD THEREOF

(71) Applicant: James Lawrence Burg, Framingham, MA (US)

(72) Inventor: James Lawrence Burg, Framingham, MA (US)

(21) Appl. No.: 13/326,937

(22) Filed: Dec. 15, 2011

(51) Int. Cl. G01N 21/64

(52) U.S. Cl. 436/501; 422/69

(57) ABSTRACT

A device including a shallow chamber for analyzing a plurality of target analytes in a body fluid using the signal generated by fluorescent detector molecules each specific for a target analyte, an attenuating dye for attenuating the signal emitted by fluorescent detector molecules specifically bound to the surfaces of the chamber other than an optically clear surface, and method for determining the signal generated by each of the plurality of analytes.

### CROSS-REFERENCE TO RELATED APPLICATIONS

This application is a continuation-in-part of International Application No. PCT/EP2011/151250, filed May 26, 2011, which claims priority to European Patent Application No. EP10005631.6, filed May 31, 2010, the entire contents of each are incorporated by reference in their entirety into the present application.

This application and related application entitled, “Fluorescent measurement in a disposable microfluidic device, Atty. Docket No. INL-113 (43057-00013), incorporated by reference herein in its entirety, are filed on even date.

### NAMES OF THE PARTIES TO A RESEARCH AGREEMENT

One or more of the inventions disclosed and/or claimed herein were made 1) on behalf of Instrumentation Laboratory Company and Microparts GmbH, parties to a joint research agreement as defined in 35 U.S.C. §103(c)(3) that was in effect before the date the claimed inventions were made, and (2) as a result of activities undertaken within the scope of the joint research agreement.

### FIELD OF THE INVENTION

The present invention relates to the quantitative optical analysis of fluorescently labeled target biological analytes of the type in a biological sample, such as a patient body fluid. The present invention is more specifically related to a device and method for achieving a true and specific optical signal arising from multiple target analytes that reflect the concentration of the analytes in the sample. The sample is tested in an assay chamber of a microfluidic device by use of an attenuating dye to allow two active, optimally parallel surfaces of the assay chamber to be interrogated for the presence or absence of more than one analyte.

### BACKGROUND OF THE INVENTION

Fluorescent measurement of a single target analyte in biomedical assays may be conducted in an assay chamber in which one portion of the chamber has an optically clear surface that is activated by coating the luminal surface with binding partners specific for a target analyte of interest in a sample. The binding partners on the optically clear active surface specifically “capture” target analyte that is subsequently detected with the use of fluorescently labeled detector molecules with specificity for the target analyte.

Several problems are encountered when detecting multiple analytes, as opposed to a single target analyte, on multiple surfaces in an assay chamber of a microfluidic device. For example, a fluorescein-labeled antibody specific to one analyte may be quantitatively distinguished from a rhodamine-labeled antibody specific to another analyte. However, this method requires a complex and costly optical system, often consisting of multiple band-path filters, to specifically excite each fluorophore with the proper wavelength energy and to specifically measure the emitted light from each fluorophore.

Another method for detecting multiple analytes on multiple surfaces in a chamber is to spatially separate binding partners on a surface or surfaces of the chamber. This method, which allows the use of a single fluorophore, suffers from the need to move the optics relative to the surface(s) (i.e. move the optical system or move the device) which can be costly, complex, and unreliable over time. This method also requires precise positioning of binding partners on surfaces which may be technically difficult and has risks of cross-contamination.

Yet another solution for multiple analyte detection is the use of parallel surfaces of a chamber that are far enough apart that refocusing the optics allows fluorescence from each surface to be distinguished or the use of two optical systems, or two optically clear surfaces. However, this method necessitates a deep chamber which may cause problems with fluidics (e.g. difficulty in filling and emptying the chamber), poor binding efficiencies due to long diffusion distances (or the need to have mixing) and thus long assay times, large reagent volumes which are costly, and an inefficient use of space.

### SUMMARY OF THE INVENTION

The present invention overcomes the drawbacks of prior art devices and methods and is directed to automated, cost-effective, high throughput solutions for detecting multiple analytes with the use of a single fluorophore, fixed optics with a single focal path and plane, and a shallow assay chamber with optimal fluidic properties. The assay is performed in a microfluidic device which permits extremely rapid test results and efficient use of costly reagents while simultaneously improving assay sensitivity and accuracy.

In one aspect the invention relates to a device, kit, or composition of matter for achieving a true and specific optical signal arising from multiple target analytes that reflect the concentration of the analytes in a sample in an assay chamber. In one embodiment, the invention includes a microfluidic device having an assay chamber with a first wall with at least a portion that is optically clear, a wall opposite the first wall, and a lumen. Optionally, the first wall is entirely optically clear. The luminal surface of the optically clear portion of the first wall is coated with first binding partners specific for a first target analyte in a sample and the luminal surface of the opposite wall is coated with second binding partners specific for a second target analyte in the sample. A third binding partner, specific for the first target analyte, is labeled with a fluorophore detector molecule, and a fourth binding partner, specific for the second target analyte, is labeled with the same fluorophore detector molecule;

The device, kit or composition includes a solution comprising a dye. The dye is capable of absorbing light of a wavelength range selected from the group consisting of emission wavelength range, excitation wavelength range, or their combination of any of the fluorescent detector label that is bound to the luminal surface of said chamber.

In one embodiment of the invention, the first binding partner is a first antibody specific for the first target analyte and the third binding partner labeled with the fluorophore is a second antibody specific for the first target analyte. The second binding partner is a first antibody specific for the second target analyte and the fourth binding partner labeled with the same fluorophore is a second antibody specific for the second target analyte.

In another embodiment, the distance between the luminal surface of the optically clear wall and the luminal surface of said opposite wall of the assay chamber is in the range of about 50 microns to 200 microns, about 75 microns to 100 microns, or 10 microns to 5.0 millimeters.

The dye is selected from the group consisting of amaranth, erioglaucine, brilliant green, and combinations thereof.

In a particular embodiment, the device, kit or composition of matter includes an optical detector for detecting fluorescent signals, and a microprocessor capable of determining the quantity of the first target analyte and the second target analyte from the fluorescent signals.

In another aspect, the invention relates to a method for detecting multiple analytes in the microfluidic device having the assay chamber described above. According to one embodiment of the method, a sample believed to have the target analytes of interest is introduced into the assay chamber. After incubation to allow binding and washing to remove unbound analyte and other sample components, third and fourth binding partners, specific for the first and second target analyte respectively and each labeled with the same fluorophore, are introduced into the chamber. Following incubation sufficient to allow binding to occur, the contents of the chamber are removed and washed with excess wash reagent. An optical measurement of fluorescence in the chamber is measured which is related to the concentration of the first and second target analytes. A solution comprising a dye or dyes is then introduced into the chamber, wherein the dye or dyes absorb light of a wavelength range selected from the group consisting of emission wavelength range, excitation wavelength range, and their combination of the chosen fluorophore. Any fluorescent detector molecules that are bound to the luminal surface of the opposite wall of the chamber will thus be masked by the dyed solution A second fluorescence measurement of the chamber is optically made. The concentration of the first and second target analytes is calculated from the two optical measurements. Optionally, the sample and the two fluorophore labeled binding partners, one specific for each target analyte, may be mixed together before introducing the sample into the chamber. Washing the chamber may occur before adding the labeled third and fourth labeled binding partners, after incubation, or before the dye is introduced into the chamber.

### BRIEF DESCRIPTION OF THE DRAWINGS

These embodiments and other aspects of this invention will be readily apparent from the detailed description below and the appended drawings, which are meant to illustrate and not to limit the invention, and in which:

FIG. 1A is a plan view of an exemplary instrument system including a microfluidic device according to one embodiment of the invention.

FIG. 1B illustrates a top cut away view of an exemplary assay chamber according to one embodiment of the invention.

FIG. 1C illustrates a bottom cut away view of the exemplary assay chamber illustrated in FIG. 1B.

FIG. 1D illustrates a top cut away view of another exemplary cylindrical assay chamber according to one embodiment of the invention.

FIG. 1E illustrates a bottom cut away view of the exemplary cylindrical assay chamber illustrated in FIG. 1D.

FIG. 1F illustrates a top view of an exemplary assay chamber and method of making according to one embodiment of the invention.

FIG. 2 is a diagrammatic cross-sectional view of an assay chamber without the addition of an attenuating dye.

FIG. 3 is a diagrammatic cross-sectional view of an exemplary assay chamber including an attenuating dye according to one embodiment of the invention.

FIG. 4 is a perspective view of an exemplary assay chamber including an optical signal portion of a wall according to one embodiment of the invention.

### DESCRIPTION

The present invention will be more completely understood through the following description, which should be read in conjunction with the attached drawings. In this description, like numbers refer to similar elements within various embodiments of the present invention. Within this description, the claimed invention will be explained with respect to embodiments. The skilled artisan will readily appreciate that the methods and systems described herein are merely exemplary and that variations can be made without departing from the spirit and scope of the invention.

As used herein, microfluidic device shall mean devices for biological assays that utilize fluid volumes on the order of picoliters to microliters. The devices have channels and/or chambers with dimensions ranging from millimeters to micrometers.

As used herein, target biological analyte shall mean an analyte or a group of analytes of interest in a biological specimen such as but not limited to pathogens, proteins, nucleic acids, lipids, antibodies, antigens and enzymes. For example, a group of analytes may be a plurality of proteins, for example, myoglobin, BNP and CK-MB, proteins of related interest by their shared utility for detecting heart failure.

As used herein, a fluorescent detector molecule shall mean any molecule, binding partner, or entity that can complex directly or indirectly with another molecule or substance and can be detected using a suitable fluorescence optic system, wherein the molecule, binding partner or entity is excited by light of an appropriate wavelength and the emitted light (at a different wavelength) is measured. The molecule, binding partner or entity may be intrinsically fluorescent or rendered fluorescent by attachment of an appropriate fluorophore.

As used herein, an attenuating dye shall mean a dye that absorbs light of a wavelength range including emission wavelength range, excitation wavelength range, or the combination of emission wavelength range and excitation wavelength range of any fluorescent detector molecule.

As used herein, a binding partner shall mean a molecule, for example, an antibody which binds specifically to a target biological analyte, or an intermediate in a binding cascade, for example, where streptavidin is coated onto a surface as an intermediate binding partner, and the streptavidin then binds to biotin which has been conjugated to an antibody that is a specific binding partner for a target biological analyte.

As used herein, background fluorescence shall mean fluorescence that has not originated from a fluorescent detector molecule bound to a target analyte of interest.

In one aspect, the invention relates to a disposable microfluidic device for optical measurement of multiple target biological analytes in a biological specimen such as, but not limited to, body tissues or a patient body fluid, for example, blood, serum, plasma, urine, sputum, cerebrospinal fluid, joint fluid, digestive fluid, tissue aspirates, exudates and transudates.

Embodiments of the invention relate to an apparatus, kit composition of matter, or method, for example, an immunoassay method, for the detection of multiple target analytes bound to different luminal surfaces of an assay chamber of a microfluidic device.

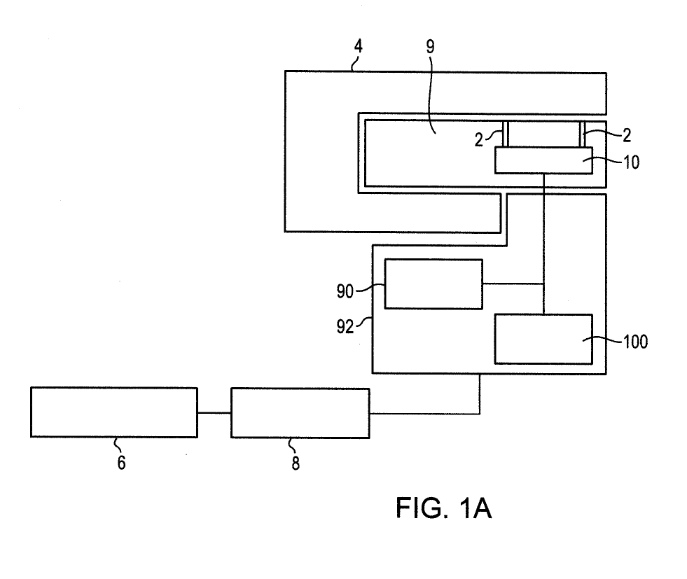

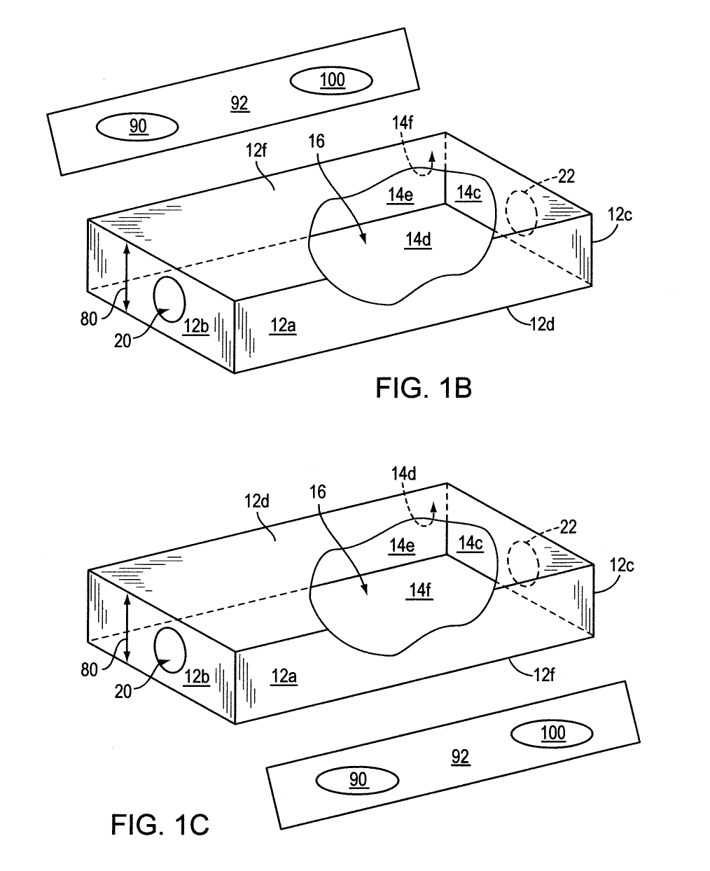

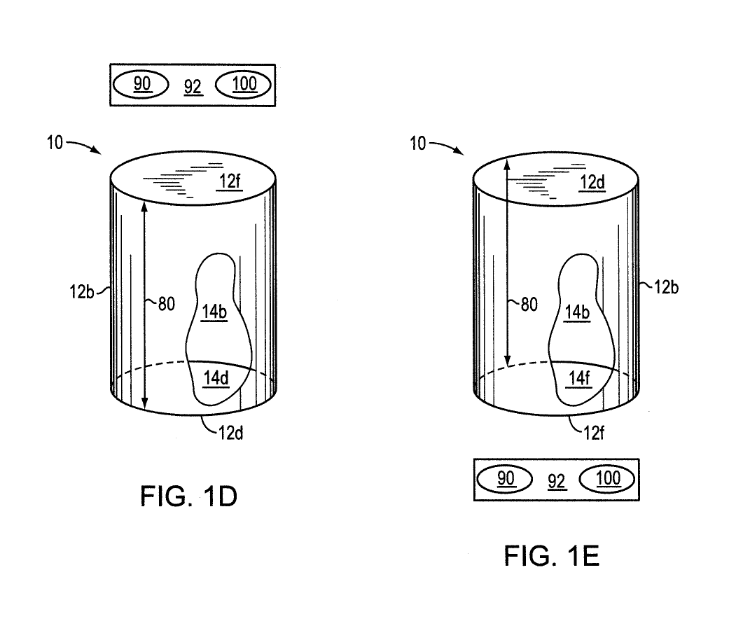

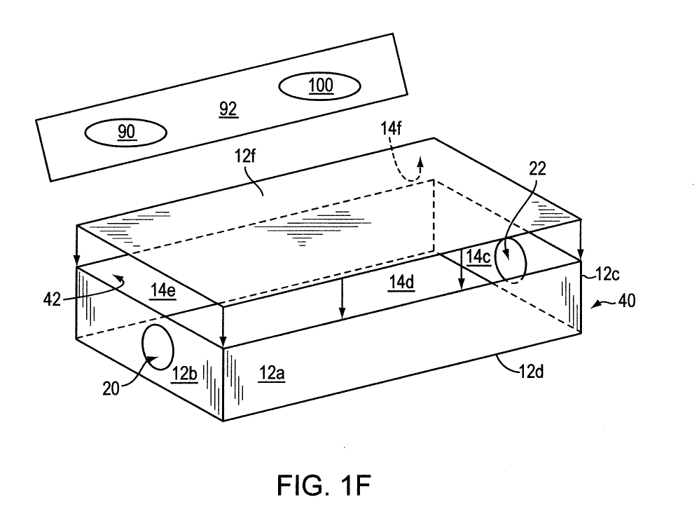

FIGS. 1A-F are exemplary embodiments of a disposable microfluidic device and instrument system according to the invention that has been developed for sensitive, accurate, cost-effective, and automated diagnostic testing of multiple target analytes of interest. In one embodiment, referring to FIG. 1A, the instrument system includes a microfluidic device 9 having an assay chamber 10 and fluid conduits 2, a microfluidic device holder 4, microprocessor 6, electronics 8, and an optical system 92 comprising an optical source 90, and an optical detector 100 for measuring optical signals such as optical signals generated by a fluorescent detector molecule bound to a target analyte in an assay chamber.

Referring to FIG. 1B, in one embodiment, the microfluidic device includes a rectangular assay chamber 10 which has 6 walls 12ₙ specifically, 12a, 12b, 12c, 12d, 12e, and 12f surrounding a chamber lumen 16. The assay chamber 10 is capable of holding a fluid when any wall is the wall closest to the source of gravitational pull. In other words, following assembly, the chamber 10 is completely enclosed on all sides with the exception of optional ports, for example, inlet port 20 and outlet port 22. In one embodiment, the chamber 10 may be a cylinder, or a channel, for example. The shape of the chamber of the microfluidic device is not limited by the shape illustrated in the figures.

Each wall 12a-12f of the chamber 10 has a luminal surface 14 adjacent the lumen 16. In one embodiment according to the invention, the chamber 10 has an inlet port 20 and an outlet port 22.

An active, optically clear wall portion is positioned within wall 12f, or optionally, as illustrated in FIG. 1B, the entire wall 12f is optically clear. The luminal surface 14f of the wall 12f, or optionally only the optically clear portion of wall 12f is activated by coating the surface with binding partners specific for a first target analyte or a first group of target analytes of interest. Wall 12d is opposite wall 12f. The walls 12d and 12f may be planar or may have one or more radii. In one embodiment, the chamber wall 12d that is opposite to the optically clear wall 12f is substantially parallel to, 0 to 45 degrees, 0 to 10 degrees, or 10 to 45 degrees, for example, relative to the plane of the optically clear wall 12f. Alternatively, the luminal surface of chamber wall 12d is substantially parallel, 0 to 45 degrees, 0 to 10 degrees or 10 to 45 degrees, for example, relative to the plane of the luminal surface of optically clear wall 12f.

An area of the luminal surface 14d of the opposite chamber wall 12d is similarly sized and positioned compared to the activated area on the luminal surface 14f of wall 12f. The luminal surface 14d is activated by coating the surface with binding partners specific for a second target analyte or group of analytes of interest. In one embodiment, the luminal surface 14 of the chamber walls 12a-c and 12e other than the luminal surface 14f of the optically clear wall 12f and the luminal surface 14d of the opposite wall 12d are uncoated with binding partners or with blocking agents or any other agents prior to initiation of an assay that would otherwise block non-specific binding to the luminal surfaces of these walls.

The assay chamber 10 may be made from a polymer, for example, but not limited to, polystyrene.

Referring to FIGS. 1B-1C, in a particular embodiment according to the invention, the assay chamber 10 is substantially rectangular with an optically clear wall 12f (or portion thereof) and a wall 12d opposite the optically clear wall 12f. The distance 80 between the luminal surface 14f of the optically clear wall 12f (or portion thereof) and the luminal surface 14d of the wall 12d opposite the optically clear wall 12f is in the range of about 10 microns to 5 millimeters, 10 microns to 2 millimeters, 10 microns to 1 millimeter, 50 microns to 200 microns, 50 microns to 125 microns, 70 microns to 100 microns, 75 microns to 150 microns, preferably 50 to 100 microns, more preferably 75 microns. The chamber lumen 16 is bounded and enclosed by the walls 12a-12f including the optically clear wall 12f and the wall 12d opposite the optically clear wall of the chamber 10. The walls other than the optically clear wall may be made from a light blocking material, for example, a black plastic. Alternatively, the walls may be optically clear.

Referring to FIGS. 1D-1E, in another embodiment according to the invention, assay chamber 10 is substantially cylindrical with wall 12f and wall 12d at opposite ends of the cylindrical chamber 10, and wall 12b joining wall 12f and 12d. Wall 12f of the chamber 10 is optically clear or, optionally, a portion of wall 12f is optically clear. The chamber wall 12d that is opposite to the optically clear wall 12f is substantially parallel, 0 to 45°, 0 to 10°, or 10 to 45° relative to the plane of the optically clear wall 12f. Alternatively, the luminal surface of chamber wall 12d is substantially parallel, 0 to 45 degrees, 0 to 10 degrees or 10 to 45 degrees, for example, relative to the plane of the luminal surface of optically clear wall 12f.

Referring still to FIGS. 1D-1E, the luminal surface 14f of the optically clear wall 12f or a portion of the luminal surface 14f of the cylindrical chamber 10 is activated by coating the surface 14f with binding partners specific for a first target analyte of interest by standard methods known to the skilled artisan. A similarly sized and positioned area of the luminal surface 14d of the opposite chamber wall 12d is activated by coating with binding partners specific for a second target analyte.

For example, in one embodiment, the size of 12d and 12f could be different, yet still parallel. Coating the entire surface of 12d and 12f would thus end up with different areas of coverage. As applied to rectangular or cylindrical shape, portions of each coated luminal surface need to at least “overlap” in the x and y dimensions separated in the z dimension) where the optical measurements are made. The cylindrical shape, for example could be more conical shaped, for example, if 12d and 12f are different sizes.

In one embodiment, the luminal surface 14b of the chamber wall 12b is uncoated with binding partners or with blocking agents or any other agents prior to initiation of an assay that would otherwise block non-specific binding to the luminal surface of this wall. The distance 80 between the luminal surface 14f of the optically clear wall 12f and the luminal surface 14d of the wall 12d is in the range of about 10 microns to 5 millimeters, 10 microns to 2 millimeters, 10 microns to 1 millimeter, 50 microns to 200 microns, 50 microns to 125 microns, 70 microns to 100 microns, 75 microns to 150 microns, preferably 50 to 100 microns, more preferably 75 microns.

The chamber may assume other shapes (e.g. shapes with curved side portions as opposed to orthogonal edges may facilitate optimal fluidic properties when introducing and removing solutions from the chamber), a channel for example, and is not limited to the illustrated rectangular or cylindrical shapes. The walls other than the optically clear wall may be made from a light blocking material, for example, a black plastic. Alternatively, the walls may be optically clear.

Referring to FIG. 1F, in one embodiment of the microfluidic device for detecting target analytes in a biological specimen according to the invention, the chamber 10 is assembled from parts into a single integrated chamber 10. For example, in one embodiment, a first chamber part is a shallow well 40 made from a polymeric material and having a wall 12d at the bottom of the shallow well 40, an open face 42 at the top of the shallow well, and well side walls 12a, 12b, 12c and 12e. The shape of the well is not limited to rectangular but may be oval, circular, or other shapes, for example.

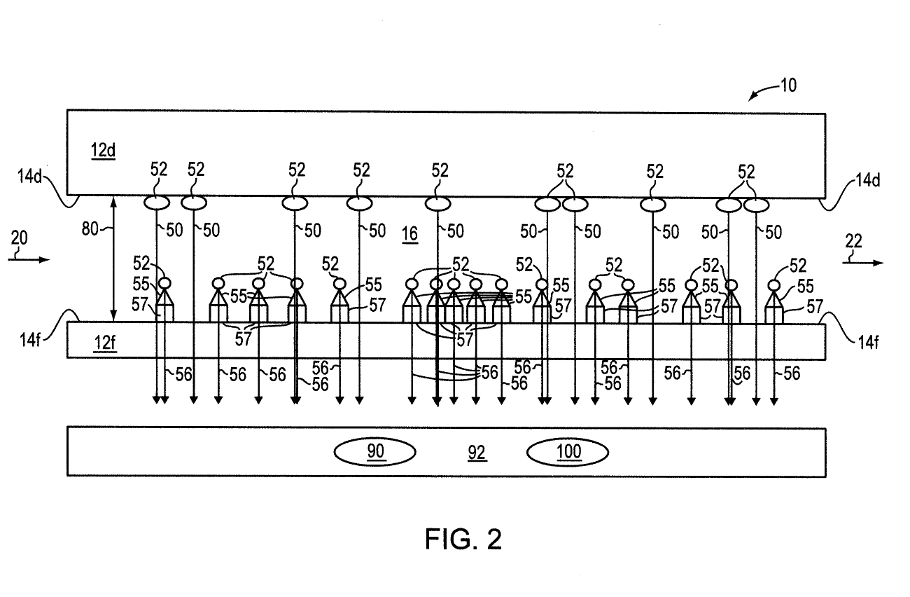

The depth of the shallow well 40 is in the range of about 10 microns to 5 millimeters, 10 microns to 2 millimeters, 10 microns to 1 millimeter, 50 microns to 200 microns, 50 microns to 125 microns, 70 microns to 100 microns, 75 microns to 150 microns, preferably 50 to 100 microns, more preferably 75 microns. An optically clear, planar wall 12f or a wall with an optically clear portion, with dimensions that correspond substantially to the open face 42 of the shallow well 40 forms a second chamber part to be joined to the shallow well 40 to form the assay chamber 10. The optically clear wall 12f, or optionally, a portion of wall 12f of the assay chamber 10 is activated by coating the surface on one side of the wall with binding partners, defined above, for the target analyte of interest (see, e.g., FIG. 2). The luminal (inside) surface 14d of the base wall 12d of the shallow well 40 is activated by applying binding partners to a second target analyte. The binding partners that are coated on the luminal surface of the chamber walls may be, but are not limited to, for example, polyclonal or monoclonal antibodies and fragments thereof specific for a target analyte, other proteins, lectins, antibodies, oligonucleotides, protein biomarkers, aptamers, receptors, protein A, protein G, biotin, or streptavidin. The coated surface 14f of the optically clear wall 12f is placed face down on the open face 42 of the shallow polymeric well 40 such that the coated surface is on the luminal side of the newly formed chamber 10.

Alternatively, in another embodiment, the shallow well 40 could be optically clear and the planar wall 12f “lid” opaque. In this case the optics would be on the shallow well 40 side.

The optically clear wall 12f of the assay chamber is affixed to the top of the walls of the shallow polymeric well 40 by adhesives, heat bonding, ultrasonic welding, or other methods of permanent attachment. In one embodiment, the luminal surfaces 14 of the shallow well portion 40 of the chamber 10 other than the luminal surface 14d of the wall 12d at the base of the shallow well 40, are not treated with any agents prior to initiation of an assay, such as blocking agents, for example, but not limited to the blocking agents casein, bovine serum albumin, and newborn calf serum.

Referring to FIG. 2, in one embodiment, a chamber 10, as described above with respect to FIG. 1B, having the luminal surface 14f of the optically clear portion 12f of the chamber coated with a specific binding partner for a first target analyte of interest, and a luminal surface 14d of the opposing wall 12d coated with another specific binding partner for a second target analyte of interest is readied for an assay. The biological specimen suspected of having the target analytes of interest is introduced into the chamber lumen. After an appropriate incubation period to allow binding of the target analytes to the binding partners on the luminal surfaces 14d and 14f, the chamber lumen is washed to remove unbound or excess analyte as well as other undesirable components of the biological specimen by introducing a volume of solution that exceeds or is equal to the volume of the chamber lumen through the inlet port. The wash solution may be removed through outlet port 22. Fluorescent detector molecules with binding affinity for the first target analyte and fluorescent detector molecules with binding affinity for the second target analyte, each using the same fluorophore, are simultaneously (e.g. mixed together in one reagent) introduced into the lumen 16 of chamber 10. The same fluorophore of the detector molecules are standard fluorescent molecules from common dye families derived from dyes xanthene (e.g. Fluorescein, Texas Red), cyanine, naphthalene, coumarin, oxadiazole, pyrene, oxazine, acridine, arylmethine, tetrapyrrole and commercial dyes including TOTO-1, YOYO-1, Alexa Fluors, Cy family (e.g. Cy2, Cy5, Cy7) and many others, as well as fluorescent molecules useful in time-resolved fluorescence such as chelates of the lanthanides, europium, samarium, and terbium.

The chamber is again washed to remove unbound fluorescent detector molecules prior to optical detection. Optionally, the fluorescent detector molecules which have binding affinity for the target analytes of interest may be pre-mixed with the sample. The mixture is then introduced into the chamber, followed by washing the chamber lumen, which is followed by optical detection.

In one embodiment according to the invention, for either target analyte, the binding partners integral to the fluorescent detector molecules are different than the binding partners that are coated on the luminal surfaces. Alternatively, the binding partners integral to the fluorescent detector molecules and the binding partners for the target analyte coated on the luminal surfaces may be the same, for example, when a target analyte is multivalent. Furthermore, the binding partners may be intermediates in a binding cascade, for example where streptavidin is coated onto the luminal surface as an intermediate binding partner. Streptavidin then binds to biotin which has been conjugated to an antibody specific for the target of interest. Each of the target analytes in the fluid sample bind to its specific binding partner of the fluorescent detector molecules when the target analytes and binding partners are contacted in solution, thereby forming fluorescently labeled first and second target analytes.

In multi-analyte detection, it is important to maintain specificity for each analyte to its respective surface. Streptavidin could be used as an intermediate during surface preparation. Other binding partners on each surface are required to ensure specificity.

A single fluorophore in this invention can discriminate two target analytes or two groups of target analytes. If greater multiplex capability is desired, further system complexities would need to be introduced, e.g., multiple fluorophores or spatial separation, both which would require the appropriate optics.

Referring to FIG. 2, for optical detection, excitation light from an optical source 90 of the optical system 92 is directed through the optically clear wall 12f of the assay chamber 10. The excitation light excites fluorescence 56 of the fluorescent detector molecules 52 bound to the first target analyte 55 which are bound to the binding partners 57 on the luminal surface 14f of the optically clear wall 12f. Similarly, fluorescence 56′ will be emitted from the fluorescent detector molecules 52′ of the second target analyte 55′ which are bound to the binding partners 57′ on the luminal surface 14d of the opposing wall 12d. The same fluorophore is used for fluorescent detector molecules 52 and 52′.

A first optical reading of the total fluorescence emitted from the first and second target analytes, as shown in FIG. 2, is measured by an optical detector 100. If only background fluorescence is measured, it may be concluded that neither the first or second target analyte is present in the sample. Detectable fluorescence indicates the presence of one, or the other, or both the first and second target analytes.

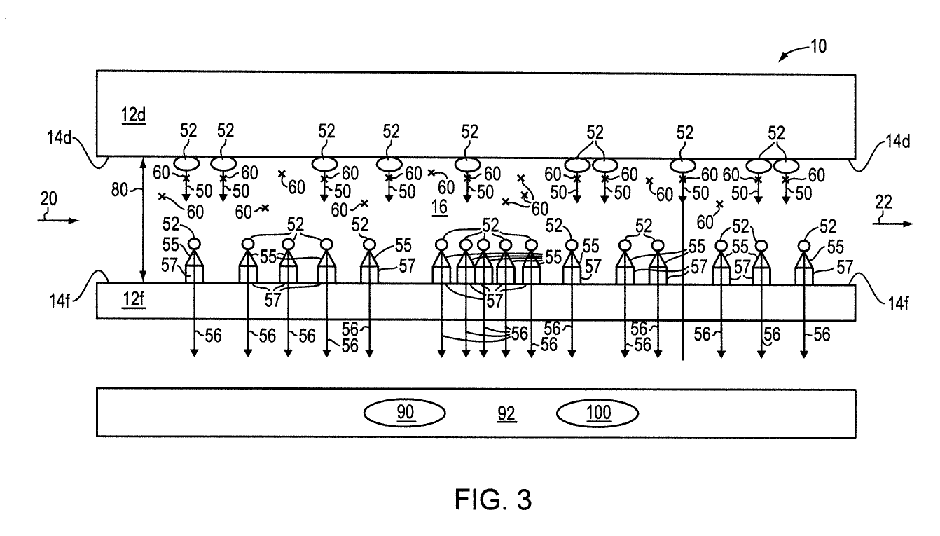

After the first optical reading is taken, now referring to FIG. 3, an attenuating dye 60 at a concentration sufficient to strongly absorb light of wavelength range near the excitation or emission wavelength ranges for the fluorophore used on the detector molecules 52 and 52′ is introduced into the lumen of the chamber. The attenuating dye 60 includes such standard non-fluorescent dyes as amaranth, erioglaucine, brilliant green, or combinations of various dyes. Fluorescence 56′ from the second target analyte 55′ that is specifically bound to the luminal surface 14d of the wall 12d opposite the optically clear wall 12f (or portion thereof) is “masked” by the one or more dyes 60 that are introduced into the chamber lumen. The specific fluorescence 56 of the fluorescent labeled first target analyte 55 bound to the binding partners 57 on the surface 14f of the optically clear wall 12f is not masked. Fluorescence is again measured. Detectable fluorescence in the presence of the attenuating dye arises essentially only from the luminal surface 14f of the optically clear wall 12f because the fluorescence from the opposing wall surface is masked by the attenuating dye.

The quantitative result of the fluorescent measurement in the presence of dye compared to fluorescence in the absence of dye as described herein allows calculation of the total fluorescence signal in the absence of dye to determine the quantity of the first and second target analytes. A microprocessor may be used to determine the quantity of the first target analyte and second target analyte by analysis of the fluorescent signals as follows. If the fluorescent signal measured by the optical detector is above background and is equivalent with and without dye, then it may be concluded that only the first target analyte 55 (or that group of analytes) is present and the magnitude of fluorescence is proportional to the amount of the first target analyte 55 in the sample. If fluorescence is detected above background in the absence of dye but only background fluorescence measured with dye, then it may be concluded that only the second target analyte 55′ (or that group of analytes) is present and the magnitude of fluorescence without dye is proportional to the amount of the second target analyte 55′ in the sample. If fluorescence above background is detected with dye, but the amount is less than the measured fluorescence without dye, then it may be concluded that both the first target analyte 55 and the second target analyte 55′ (or respective groups of analytes) are present in the specimen. In this case, the amount of fluorescence with dye is proportional to the amount of the first target analyte 55 in the sample, and the difference in fluorescence without and with dye is proportional to the amount of the second target analyte 55′ in the sample. Analyte combinations and fluorescence signals with and without the use of the attenuating dye in the chamber is summarized in Table I below.

TABLE #1
Analyte Combinations and Fluorescence
Signals With and Without Dye

| Analyte | Analyte | Fluorescence | Fluorescence | |
|---|---|---|---|---|
| #1 | #2 | Without Dye | With Dye | Comment |
| No | No | Not | Not | Only background |
| | | detectable | detectable | fluoresence |
| | | | | measured |
| Yes | No | X | X | “X” fluorescence |
| | | | | proportional to |
| | | | | analyte #1 |
| No | Yes | X | Not | “X” fluorescence |
| | | | detectable | proportional to |
| | | | | analyte #2 |
| Yes | Yes | X | Y | “Y” fluorescence |
| | | | | proportional to |
| | | | | analyte #1 and |
| | | | | “X − Y” |
| | | | | fluorescence |
| | | | | proportional |
| | | | | to analyte #2 |

In order to increase the multiplex power to discriminate multiple target analytes, the dual surface and attenuating dye invention disclosed herein can be combined with other common practices for multi-analyte detection. For example, two fluorophores could be used to detect and discriminate two analytes on one luminal surface, for example, luminal surface 14f of the wall 12f, and optionally, the same two fluorophores could be used to detect and discriminate two additional analytes on another luminal surface, for example, luminal surface 14d of the wall 12d. This would allow specific detection and quantitation of 4 analytes or analyte groups, although requiring more complex optics to excite and measure the two fluorophores. Similarly, in yet another embodiment, four spatially distinct activated luminal surfaces on one wall with one fluorophore could also be duplicated onto the opposite luminal surface to detect a total of eight target analytes, with a single fluorophore, although complex optics are required to specifically measure the spatially separated active areas

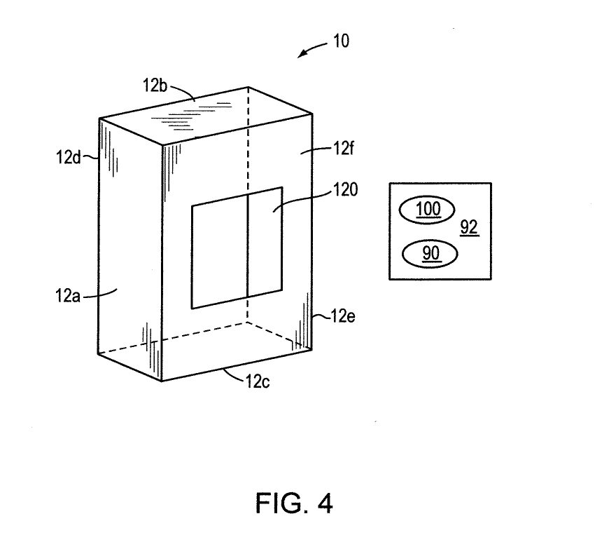

Referring to FIG. 4, in one embodiment according to the invention, the optics of the instrument are arranged to detect fluorescence only from the luminal surface 14f of the optically clear wall 12f or a portion thereof and from the luminal surface 14d of the wall 12d opposite to the optically clear wall 12f while not detecting fluorescence that may be emitted from the side walls or any other wall portion of the chamber 10.

For example, referring still to FIG. 4, in a rectangular assay chamber 10 according to the invention having a chamber depth of 0.1 mm and outside dimensions of 6 mm×2 mm, in one embodiment, the optically clear wall 12f of the chamber is 6 mm×2 mm. Referring still to FIG. 4, in this embodiment, only a 1 mm×1 mm optical signal portion 120 of the center, for example, of the 6 mm×2 mm optically clear wall 12f, the center, for example, is utilized for the optical signal. Accordingly, the signal due to non-specific binding of the fluorescent detector molecules on wall surfaces such as the sides of the chamber other than the actuated surface of the optically clear wall and opposite wall surface is substantially eliminated.

Competitive binding assays are also contemplated by the invention. In a competitive format, fluorescently labeled target analytes are added to the reaction to compete with unlabeled target analytes in a specimen. Instead of looking for increased fluorescence when the analyte is present in the specimen, the competitive format looks for decreased fluorescence. A table analogous to Table #1 can be constructed for the competitive format. It would be approximately the inverse of the current table. For example, in the absence of either analyte, one would expect strong fluorescence from both the luminal surface 14d and the luminal surface 14f.

### Exemplification

Myoglobin and BNP are exemplary first and second target analytes in a biological specimen that may be detected in the microfluidic device according to the invention described above.

Referring first to FIG. 2, the exemplary chamber is shallow having a depth 80, for example, of about 75 microns. A binding partner, a monoclonal antibody, for example, directed to a specific epitope of myoglobin may be used as the binding partner that is applied to the luminal surface 14f of the optically clear wall 12f. Another binding partner, a second monoclonal antibody, for example, directed to a specific epitope of BNP may be used as the second binding partner that is applied to the luminal surface 14d of the opposite wall 12d. The biological specimen is introduced into the chamber lumen to allow binding of the target analytes to the respective surface bound monoclonal antibodies. After sufficient time to allow binding of the target analytes to their relevant binding partner to occur, the chamber lumen is washed to remove unbound myoglobin and BNP as well as other components in the biological specimen. A fluorescently labeled monoclonal antibody directed to a different epitope of myoglobin and a fluorescently labeled monoclonal antibody directed to a different epitope of BNP, both using the same fluorophore, are then simultaneously introduced (as a single mixed reagent) into the chamber lumen. After sufficient incubation time, the fluorescently labeled monoclonal antibodies bind to their respective target analytes to form fluorescently labeled target analytes. The chamber is then washed without dye to remove unbound fluorescently labeled antibodies. Without the presence of an attenuating dye such as amaranth in the system, fluorescence from europium originating from the surface of the optically clear wall where myoglobin is bound and fluorescence arising from the opposite wall where BNP is bound will be optically detected as combined signal.

After total fluorescence arising from the luminal surface of the opposite wall and the luminal surface of the optically clear wall is measured, referring to FIG. 3, an attenuating dye such as amaranth is introduced into the chamber lumen. The attenuating dye blocks fluorescence arising from the luminal surface 14d of the opposite wall 12d. The optical signal measured in the presence of the attenuating dye relates to the fluorescence 56 arising only from the luminal surface 14f of the optically clear wall 12f. As described above, by utilizing the fluorescence measured in the presence and absence of the attenuating dye, it is possible to calculate the specific fluorescent signals arising from myoglobin and the specific fluorescent signal arising from BNP and by applying these signals to appropriate standard curves, the concentration of myoglobin and BNP can be determined while using a single fluorophore and fixed optics.

One skilled in the art will recognize variations in the implementation of using attenuating dye with multiple surfaces to achieve multiplex analyte detection. Such variations include alternative assay formats such as competitive formats. Further, the chamber could first be washed with dye to remove unbound fluorescently labeled antibodies, fluorescence measured, then the chamber is washed again with a washing reagent without dye, and a second fluorescence measurement is taken.

According to one embodiment of a method of the invention for measuring multiple target analytes in a biological sample, a microfluidic device having an assay chamber is provided. The assay chamber has a lumen enclosed by walls and an optional inlet and an outlet port. One chamber wall or a portion of it is optically clear for transmission of fluorescent light emitted from within the chamber to an optical detector outside the chamber for measuring the amount of fluorescence within the chamber. Another chamber wall is opposite the optically clear wall.

The surface of the optically clear wall or portion of it is coated with specific binding partners for a first target analyte of interest and the surface of the opposite wall or a similarly positioned portion of it is coated with specific binding partners for a second target analyte of interest in the biological specimen.

In a one-step assay, the biological specimen is mixed with at least two binding partners each labeled with a single fluorophore; each binding partner having specificity for one of the target analytes. The specimen and the fluorescent detector molecules with binding partners are introduced into the lumen of the assay chamber.

Alternatively, in a two-step assay, the sample alone is added to the chamber lumen, a sufficient time is allowed for binding to occur, followed by the addition of the fluorescent detector molecules. Typically, the chamber is washed before the fluorescent detector molecules are introduced into the lumen of the assay chamber.

After incubation to allow binding events to occur to ensure capture of the analytes or analyte groups, along with the fluorescent label, specifically, to either the luminal surface of the optically clear wall or the luminal surface of the opposite wall, the solution including the biological sample and the unbound fluorescent detector molecules are removed from the chamber and the chamber is washed with a volume of wash reagent exceeding or equal to the volume of the chamber.

Fluorescence is measured. The measured fluorescence is the sum of the fluorescence from the luminal surface of the optically clear wall and the opposing wall. If only background fluorescence is measured, it may be concluded that neither target analyte is present in the sample. Detectable fluorescence would indicate that both target analytes, or either of the two target analytes are present in the biological specimen.

Next, the chamber lumen is filled with a volume of a solution including one or more attenuating dyes as described above. The dye solution volume is approximately equal to the volume of the chamber. Fluorescence is measured a second time. Detectable fluorescence in the presence of dye arises only from the optically clear inner surface because fluorescence from the luminal surface of the opposite wall is “masked” by the attenuating dye in the chamber lumen. The detectable fluorescence is related to the amount of the first target analyte in the biological specimen.

According to a method of the invention, the amount of the first target analyte may be determined when the fluorescent signal is above background and is equivalent with and without dye; the amount of the second target analyte may be determined when the fluorescent signal is above background but only background fluorescence is measured in the presence of dye. The amount of the first target analyte and the amount of the second target analyte may be determined when fluorescence above background is measurable in the presence of dye, but the amount of fluorescence is less than the measured fluorescence without dye, then the amount of the first target analyte is related to fluorescence in the presence of dye, and the difference in fluorescence in the absence and presence of dye is proportional to the amount of the second target analyte in the sample. To determine the amount of the target analytes in the biological specimen, the measured detectable signals are compared to a calibration curve for each analyte.

The above described device and method can be used to detect the presence or absence of multiple target analytes using a single fluorophore in the absence of any other detector molecules, fixed optics with a single focal plane and path and a microfluidic device having a shallow chamber with optimal fluidic properties. Accordingly, the described device and method of the invention improves the accuracy of fluorescence-based in vitro medical diagnostic tests thereby leading to improved patient care.

Variations, modification, and other implementations of what is described herein will occur to those of ordinary skill in the art without departing from the spirit and scope of the invention as claimed. Accordingly, the invention is to be defined not by the preceding illustrative description but instead by the spirit and scope of the following claims.

1. A method for attenuating non-specific fluorescence in a microfluidic device for detecting the presence of multiple target analytes, comprising:
(i) providing a microfluidic device having an assay chamber comprising a first wall, wherein at least a portion of said first wall is optically clear, a wall opposite to the optically clear wall, and a lumen, the luminal surface of said optically clear wall coated with first binding partners specific for a first target analyte in a biological specimen and the luminal surface of said opposite wall coated with second binding partners specific for a second target analyte;
(ii) introducing into said chamber a third binding partner for said first target analyte, said third binding partner labeled with a fluorophore detector molecule, and a fourth binding partner for said second target analyte said fourth binding partner labeled with said fluorophore detector molecule;
(iii) incubating to allow binding events to occur;
(iv) removing the contents of said chamber;
(v) optically measuring fluorescence in said chamber, wherein the optical measurement is related to the concentration of the first and second target analytes;
(vi) introducing a solution comprising a dye into the chamber, wherein the dye absorbs light of a wavelength range selected from the group consisting of emission wavelength range, excitation wavelength range, and their combination of said fluorescent detector molecule
(vii) optically measuring fluorescence in said chamber, wherein the optical measurement is related to the concentration of the first target analyte;
(viii) calculating the concentration of the second target analyte from the optical measurements of step (v) and step (vii).

2. The method of claim 1 wherein the binding partners coated on the luminal surface of said chamber walls comprise an intermediate binding partner.

3. The method of claim 1 wherein the luminal surfaces of said chamber other than said optically clear wall and said opposite wall are uncoated with a binding or a blocking agent.

4. The method of claim 1 wherein said first wall is entirely optically clear.

5. The method of claim 1 further comprising washing said chamber between step (iv) and step (v).

6. The method of claim 1 further comprising washing said chamber between step (v) and step (vi).

7. The method of claim 1 wherein said chamber lumen is enclosed completely by at least the wall opposite the optically clear wall and said optically clear wall.

8. The method of claim 1 wherein said first binding partner comprises a first antibody specific for said first target analyte, and said third binding partner labeled with said fluorophore comprises a second antibody specific for said first target analyte.

9. The method of claim 1 wherein said second binding partner comprises a first antibody specific for said second target analyte, and said fourth binding partner labeled with said fluorophore comprises a second antibody specific for said second target analyte.

10. The method of claim 1 wherein optically measuring comprises measuring an optical signal arising from said first or said second target analyte labeled with a fluorophore and bound to the luminal surface of a chamber wall.

11. The method of claim 1 wherein the distance between the luminal surface of said optically clear wall and the luminal surface of the opposite wail is in the range of about 10 microns to 5.0 millimeters.

12. The method of claim 1 wherein the distance between the luminal surface of said optically clear wall and the luminal surface of the opposite wall is in the range of about 75 microns.

13. The method of claim 1 wherein the distance between the luminal surface of the optically clear wall and the luminal surface of the opposite wall in the range of about 50 microns to 200 microns.

14. The method of claim 1 wherein the distance between the luminal surface of the optically clear wall and the luminal surface of the opposite wall is in the range of about 75 microns to 100 microns.

15. The method of claim 1 wherein said dye is selected from the group consisting of amaranth, erioglaucine, and brilliant green, and combinations thereof.

16. The method of claim 1 wherein step (viii) comprises subtracting the measurement in step (vii) from the measurement in step (v).

17. A composition of matter, comprising:
a microfluidic device comprising an assay chamber for detecting a target analyte, said assay chamber comprising a first wall wherein at least a portion of said first wall is optically clear, a will opposite to the optically clear wall, and a lumen, the luminal surface of said optically clear wall coated with first binding partners specific for a first target analyte in a sample and the luminal surface of said opposite wall coated with second binding partners specific for a second target analyte in the sample;
a third binding partner for said first target analyte labeled with a fluorophore detector molecule, and a fourth binding partner for said second target analyte labeled with said fluorophore detector molecule;
a solution comprising a dye, the dye capable of absorbing light of a wavelength range selected from the group consisting of emission wavelength range, excitation wavelength range, or their combination of any said fluorescent detector label that is hound to the luminal surface of said chamber.

18. The composition of matter according to claim 17 wherein said first binding partner comprises a first antibody specific for said first target analyte, and said third binding partner labeled with said fluorophore comprises a second antibody specific for said first target analyte.

19. The composition of claim 17 wherein said second binding partner comprises a first antibody specific for said second target analyte, and said fourth binding partner labeled with said fluorophore comprises a second antibody specific for said second target analyte.

20. The composition of claim 17 wherein the distance between the luminal surface of said optically clear wall and the luminal surface of said opposite wall is in the range of about 10 microns to 5.0 millimeters.

21. The composition of claim 17 wherein the distance between the luminal surface of said optically clear wall portion and the opposite wall portion is in the range of about 75 microns.

22. The composition of claim 17 wherein the distance between the luminal surface of said optically clear wall and the luminal surface of said opposite wall is in the range of about 50 microns to 200 microns.

23. The composition of claim 17 wherein the distance between the luminal surface of said optically clear wall and the luminal surface of said opposite wall is in the range of about 75 microns to 100 microns.

24. The composition of claim 17 wherein said dye is selected from the group consisting of amaranth, erioglaucine, brilliant green, and combinations thereof.

25. The composition of claim 17 further comprising an optical detector for detecting fluorescent signals, and a microprocessor capable of determining the quantity of the first target analyte and the second target analyte from the fluorescent signals.

26. The composition of claim 17 wherein said first wall is entirely optically clear.

27. A method for detecting the presence of multiple target analytes in an assay chamber, comprising:
(i) providing a microfluidic device having an assay chamber comprising a first wall, wherein at least a portion of said first wall is optically clear, a wall opposite to the optically clear wall, and a lumen, the luminal surface of said optically clear wall coated with first binding partners specific for a first target analyte in a biological specimen and the luminal surface of said opposite wall coated with second binding partners specific for a second target analyte in said biological specimen;
(ii) introducing said biological specimen into the chamber
(iii) introducing into said chamber a third binding partner for said first target analyte, said third binding partner labeled with a fluorophore detector molecule, and a fourth binding partner for said second target analyte said fourth binding partner labeled with said fluorophore detector molecule;
(iv) incubating to allow binding events to occur;
(v) removing the contents of said chamber;
(vi) optically measuring fluorescence in said chamber, wherein the optical measurement is related to the concentration of the first and second target analytes;
(vii) introducing a solution comprising a dye into the chamber, wherein the dye absorbs light of a wavelength range selected from the group consisting of emission wavelength range, excitation wavelength range, and their combination of said fluorescent detector molecule
(viii) optically measuring fluorescence in said chamber, wherein the optical measurement is related to the concentration of the first target analyte;
(ix) calculating the concentration of the second target analyte from the optical measurements of step (vi) and step (viii).
